(19) United States
(12) Patent Application Publication
(10) Pub. No.: US 2013/0277872 A1
(43) Pub. Date: Oct. 24, 2013

(54) PROCESS FOR THE PRODUCTION OF ACTIVE SUBSTANCE BEADS

(71) Applicants: Craig Vincze, Reno, NV (US); Lori Jensen, Washoe Valley, NV (US); Mareen Schmökel, Schweiz (CH); Frieder Neuhäusser-Wespy, Schweiz (CH); Carsten Etzold, Schweiz (CH)

(72) Inventors: Craig Vincze, Reno, NV (US); Lori Jensen, Washoe Valley, NV (US); Mareen Schmökel, Schweiz (CH); Frieder Neuhäusser-Wespy, Schweiz (CH); Carsten Etzold, Schweiz (CH)

(73) Assignees: Hamilton Bonaduz AG, Schweiz (CH); HAMILTON COMPANY, Reno, NV (US)

(21) Appl. No.: 13/822,697

(22) PCT Filed: Sep. 2, 2011
(86) PCT No.: PCT/EP2011/065186

§ 371 Date: Jul. 10, 2013

(30) Foreign Application Priority Data
Sep. 14, 2010 (DE) 10 2010 040 687.2

(51) Int. Cl. A61J 3/02

(52) U.S. Cl. CPC A61J 3/02
USPC 264/13

(57) ABSTRACT

The present invention relates to a process for the automated production of active substance beads having a gel-like carrier material, preferably a biopolymer, such as agarose, and having embedded in the carrier material a biologically active material, such as an active substance and/or a material which generates an active substance, comprising the following steps:

a) provision of a flowable, solidifiable mixture comprising the carrier material and the biologically active material,

b) solidification of a core bead by introducing a predetermined amount of the flowable mixture into a fluid bath, preferably a liquid bath, particularly preferably an oil bath,

c) removal of the core bead from the fluid bath,

wherein for carrying out step c), a bead contact surface of a bead receiving tool is used, and for this purpose step c) comprises either the following sub-step ca1) or the following sub-step cb1):

ca1) creation of a locating engagement between the core bead and a preferably concave bead reduced-pressure contact surface of a bead reduced-pressure receiving tool by means of reduced pressure, or

cb1) creation of a locating engagement between the core bead and a preferably concave bead gravity contact surface of a bead gravity receiving tool in the fluid bath by means of gravity.

The present invention relates to a process for the automated production of active substance beads having a gel-like carrier material, preferably a biopolymer, such as agarose, and having embedded in the carrier material a biologically active material, such as an active substance and/or a material which generates an active substance, comprising the following steps:
a) provision of a flowable, solidifiable mixture comprising the gel-like carrier material and the biologically active material,
b) solidification of a core bead by introducing a predetermined amount of the flowable mixture into a fluid bath, preferably a liquid bath, particularly preferably an oil bath,
c) removal of the core bead from the fluid bath.

In medicine, active substance beads have acquired enormous importance as depot medication as a result of the treatment successes achieved therewith.

Active substance beads as a rule comprise a carrier material, in which may be embedded an active substance or a material which, due to a chemical and/or biological reaction, generates an active substance over a finite action time.

Since the active substance of the active substance bead as a rule becomes effective after its absorption in the human or animal body, in the present application the active substance and the material which generates the active substance are designated by the generic term of biologically active material. As a rule, the intended purpose of the active substance beads discussed here is that of being introduced into the human or animal body by an invasive, in particular a surgical method. For effective release of the active substance they must therefore be in a stable form at the usual body temperature of the absorbing body over a relatively long period of time, for some days at least.

Gel-like materials have proved to be a suitable carrier material, and of these biopolymers, such as agarose in particular, occupy a prominent position due to their good tolerability in the human or animal body.

In principle, carrier materials for embedding the biologically active materials therein are originally in the form of a shapeless, flowable but solidifiable mass into which the biologically active material can be mixed.

In the course of its solidification, the active substance bead assumes a certain, usually spherical, shape, wherein however the dimensional stability of the active substance bead is not particularly high, depending on the progress of the solidification, and it is not comparable with a rigid solid.

In contrast, for example, to the freezing of water, the solidification of gel-like materials is based on a change in molecular shape. While water freezes to a solid at the particular freezing point by its molecules arranging themselves in a defined lattice structure, in gel formation molecular structures are formed, such as double helices in the case of polysaccharide chains. The double helices in turn assemble together in groups to form thick threads. A type of crosslinking thus occurs, which is comparable to a denaturing operation in proteins. Due to the solidification mechanism described, gel-like materials, in particular biopolymers, particularly preferably agarose, are porous.

The low dimensional stability during the production phase moreover makes the active substance bead particularly sensitive to the action of extraneous force, which hitherto has made automated production of active substance beads very difficult. In fact, for numerous applications active substance beads are produced virtually completely manually.

A generic production process for active substance beads is known, for example, from US RE38,027 E, which carries the U.S. application Ser. No. 09/345196 and is a continuation application of the US application with the application Ser. No. 08/181269. The process described therein, nevertheless, is carried out manually.

Active substance beads in the sense of the present application are known, for example, from U.S. Pat. No. 7,297,331 B2. This publication discloses beads in which cancer cells, as the material which generates the active substance, are embedded in a spatially restricted manner in the carrier material and, due to the restriction, generate and release an active substance which inhibits the proliferation of cancer cells. The known active substance bead is constructed such that the cancer cells, as the biologically active material, are provided in a core bead which, for spatial restriction of the possible proliferation of the cancer cells embedded in the carrier material of the core bead, is surrounded by a coating, which in the known case likewise comprises a carrier material.

While the proliferation of the cancer cells is impeded by the coating and therefore they generate the proliferation-inhibiting active substance, the active substance itself can penetrate through the coating and enter into the external environment of the active substance bead.

If such an active substance bead is implanted, for example, in diseased tissue, by using the active substance released by the active substance bead the proliferation of cancer cells in the surrounding tissue can thereby be reduced or even prevented completely.

The active substance beads known from U.S. Pat. No. 7,297,331 B2 are also produced exclusively manually.

The object of the present invention is therefore to provide a technical teaching which makes possible at least a partial automation of the production of active substance beads, in particular of active substance beads according to U.S. Pat. No. 7,297,331 B2, which comprise a carrier material and a biologically active material embedded therein.

This object is achieved according to the invention in a process of the type mentioned at the outset in that for carrying out the step of removing the core bead from the fluid bath, a bead contact surface of a bead receiving tool is used, wherein between the core bead and the bead contact surface of the bead receiving tool an abutting engagement is created, by means of which the core bead adjoins the bead contact surface of the bead receiving tool.

Directly after its removal from the fluid bath, the core bead as a rule has such a low dimensional stability that it deforms recognisably under the load of its own weight, for example is flattened considerably with respect to a spherical form on the abutment site and on the diametrically opposite site.

According to the invention, the abutting engagement can be created by applying two alternative physical mechanisms of action.

According to a first embodiment of the process according to the invention, the bead contact surface is a bead reduced-pressure contact surface and the bead receiving tool is a bead reduced-pressure receiving tool, so that the abutting engagement between the core bead and the bead reduced-pressure contact surface is generated by means of reduced pressure.

It has in fact been found, surprisingly, that the core bead, which is conventionally very sensitive to the action of extraneous force and is elastically deformable by this, can be taken hold of reliably with a bead reduced-pressure contact surface by applying reduced pressure such that its own weight can be overcome by means of the bead reduced-pressure receiving tool without there being the risk of damage to the core bead during holding.

Alternatively, the bead contact surface can also be constructed as a bead gravity contact surface of a bead gravity receiving tool, wherein the abutting engagement between the core bead and the bead gravity contact surface in the fluid bath is then created by means of gravity. This can be effected particularly advantageously by the core bead, driven by gravity in the fluid bath, being allowed to sink onto the bead gravity contact surface.

Preferably, the two abovementioned embodiments of bead contact surfaces, that is to say the bead reduced-pressure contact surface and the bead gravity contact surface, are concave in construction, so that an abutment section of the bead contact surface on which the abutting engagement between the core bead and the bead contact surface takes place can serve as an osculating surface section on the conventionally convexly curved surface of the core bead.

The alternative embodiment for creating the abutting engagement by means of gravity is possible, since the abutting engagement is effected in the fluid bath, wherein the core bead, slowed down in its sinking speed by the fluid bath, comes to be in abutment with the bead gravity contact surface with a moderate impact speed. The bead gravity contact surface is advantageously at rest during creation of the abutting engagement by means of gravity, in order to avoid damage to the core bead by movement of the bead gravity receiving tool.

Particularly, if the abutting engagement between the core bead and the bead contact surface is created by means of reduced pressure, it is advantageous if the fluid bath in which the core bead to be received is initially present is emptied before creating this abutting engagement. This can prevent an undesirably large amount of fluid of the fluid bath from being sucked up by the bead reduced-pressure receiving tool and the action of the bead reduced-pressure receiving tool from possibly thereby being impaired.

As has already been stated above, it is particularly advantageous if the flowable but solidifiable mixture, which is to form the core bead and which comprises both the carrier material and the biologically active material, is introduced into the fluid bath for solidification of the core bead and sinks in the fluid bath in the gravitational direction, or falls more slowly in the fluid bath due to the viscosity of the fluid. By utilising gravity, without a further measure for movement of the core bead or its starting material through the fluid bath, a sufficient transit zone through the fluid bath for the required solidification can thus be provided.

It is then particularly advantageous if the bead gravity contact surface is provided in the gravitational direction at a distance from an introduction point at which the predetermined amount of the flowable mixture which later forms the core bead is introduced into the fluid bath, and indeed advantageously before the predetermined amount of flowable mixture is introduced into the fluid bath. By this means it can be ensured that the predetermined amount of flowable mixture which solidifies to form a core bead reliably arrives merely by sinking in the fluid bath at the bead gravity contact surface for abutting engagement.

In this context, it should not be ruled out that between the bead gravity contact surface and the introduction point, in addition to displacement in the gravitational direction, there is also a displacement orthogonally to this, for example because the at least partly already solidified core bead is not to fall freely through the fluid bath but is to roll along an inclined plane. This may possibly be desirable in order to generate core beads having a desired shape.

When a core bead has been removed from the fluid bath, a residue of fluid then conventionally adheres to the outer surface thereof, which is often undesirable for the further use of the core bead. According to a further development of the process according to the invention described herein, it is therefore intended to clean the core bead by removing the fluid of the fluid bath from the core bead.

The introduction of a predetermined amount of the flowable mixture described above for solidification of a core bead into a fluid bath can take place with particularly accurate metering if it comprises aspiration of an amount of the flowable mixture and dispensing of the predetermined amount of the flowable mixture into the fluid bath. This can advantageously be effected with a pipetting device which is known per se and is constructed for accurate metering of flowable media.

In this context, in a particular procedure a drop with the predetermined amount of the flowable mixture detaches itself from a pipetting device used for aspiration and dispensing, before the flowable mixture comes into contact with the fluid of the fluid bath. By this means, due to its surface tension, the completely detached drop assumes the desired spherical shape, before it is immersed in the fluid bath for solidification. An active substance bead having an advantageous spherical form can thereby be achieved.

In order to avoid undesirable deformation of the mixture drop in the fluid bath, it may be provided that the fluid of the fluid bath—apart from possible convection flows due to a temperature gradient in the fluid bath which is described in more detail below—is at rest relative to the pipetting device during dispensing of the mixture, in particular is not part of a circulation flow.

For certain uses of active substance beads, after solidification the core bead can already be employed as an active substance bead, for example as an active substance depot.

However, if a bead such as is described for cancer therapy in U.S. Pat. No. 7,297,331 B2 is to be used as the active substance bead, the process described herein then advantageously has the further step of coating of the core bead with a coating material. This coating material can in principle be any desired suitable material, and comprises or preferably is the carrier material or at least a material which is compatible with the carrier material, in order to be able to ensure good bonding between the core bead and the coating.

The coating described above can be effected, for example, by introducing the core bead into a bath of flowable, solidifiable coating material. In particular if the coating material comprises or even consists of the carrier material or a material compatible therewith, a film of coating material will already adhere to the core bead from the first contact of the core bead with the flowable coating material, and can be further formed into a coating by solidification.

A further sub-step of the coating of the core bead can therefore comprise removal of the bead blank of the core bead with coating material adhering thereto from the coating material bath. In the following, the term “bead blank” always designates a core bead with not completely solidified, that is to say still flowable coating material adhering thereto. When the coating material has solidified completely, the coated construction discussed here for the active substance bead is then produced, so that this is referred to as the “active substance bead”.

Since after removal of the bead blank from the coating material bath the coating material adhering to the core bead is not yet completely solidified, the abovementioned step of coating of the core bead should comprise solidification of the bead blank. This can advantageously be effected by introducing the bead blank into a bead fluid bath, analogously to the solidification described above for the core bead. Preferably, the bead fluid bath, like the abovementioned fluid bath, is a liquid bath, since this can absorb a particularly large amount of heat per unit time. Of the liquids which can be used for the formation of a liquid bath, an oil is preferred, since oils and the biopolymers preferred as the carrier material as a rule are chemically inert, that is to say do not react chemically with one another.

Oils and the biopolymers preferred as the carrier material furthermore are as a rule physically incompatible, which means that the oil of the fluid bath does not mix with the carrier material or coating material of the core bead or bead blank. The active substance bead therefore remains pure.

As already described above for the core bead, the process can comprise removal of the coated bead from the bead fluid bath. This can be effected in the same manner as has been described above in connection with the core bead and its removal from the fluid bath. With respect to the possible sub-steps for removal of the bead from the bead fluid bath and the advantages thereof, reference is therefore made to the above description of the removal of the core bead from a fluid bath.

An essential point for the bead blank is removal thereof from the coating material bath, since the bead blank formed in this way is extremely sensitive to the action of extraneous mechanical forces because of a lack of solidification of the coating material adhering to the core bead.

It has been found here that a reliable removal of the bead blank from the coating material bath can be effected by a bead blank receiving tool by means of reduced pressure.

Particularly preferably, the bead blank receiving tool for this purpose is tubular in configuration at least in sections, so that the bead blank to be received can be inserted into the tubular section of the receiving tool by reduced pressure. The bead blank received in the bead blank receiving tool is then advantageously completely surrounded by a tubular wall of the bead blank receiving tool.

The bead blank receiving tool furthermore is advantageously matched to the size of the bead blank such that in the received state the bead blank touches a wall section of the bead blank receiving tool or, in the case of a still flowable coating, wets it. In this context, handling of the bead blank with reduced pressure functions particularly well if the bead blank touches or wets the wall section, which is conventionally an inner wall section of the bead blank receiving tool, along a closed circumferential contact region or wetting region, since in this way it can divide the receiving tool into two pressure zones separated from one another, so that pressure differences can act particularly well on the bead blank and can be developed in a stable manner at the receiving tool.

According to a further development of the present process, the above statements on the cleaning of the core bead after removal from the fluid bath also apply to the bead removed from the bead fluid bath.

It is expressly pointed out once more that, in a preferred embodiment of the present process, the fluid bath for solidification of the core bead and the bead fluid bath for solidification of the bead blank can be essentially the same fluid bath, at any rate preferably using the same fluid.

Preferably, for reliable solidification of the active substance bead, a carrier material which can be thermally solidified is used, in particular one which can be thermally solidified by release of heat to an environment of lower temperature.

If a carrier material which can be thermally solidified is used, active substance beads can be produced particularly gently and at the same time reliably if the fluid bath is provided with a temperature gradient in a direction of introduction, along which the predetermined amount of flowable mixture or the bead blank is introduced into the fluid bath or bead fluid bath.

The temperature gradient can then be chosen such that the temperature of the fluid of the fluid bath or bead fluid bath changes in the direction of introduction in a sense which promotes the solidification of the mixture or of the bead blank.

For example, if the carrier material can be solidified by cooling, the temperature of the fluid bath or bead fluid bath can decrease in the direction of introduction.

In this context, it is advantageous if the fluid chosen for the fluid bath is one of which the viscosity increases with decreasing temperature, that is to say it becomes more viscous as the temperature decreases. As a result, the sinking speed of the core bead in the fluid in fact decreases as the depth of penetration increases, so that the release of heat by the core bead into the fluid becomes ever greater by reaching zones of lower temperature, which accelerates the solidification of the core bead.

In the preferred case of agarose as the carrier material, the flowable mixture can be provided in a temperature range of from 60° C. to 100° C., in particular from 65° C. to 85° C., particularly preferably of about 70° C. This ensures the flowability of the gel-like carrier material.

According to a preferred development of the present invention, the fluid bath is provided in a temperature-controlled manner such that the introduction zone into which the flowable mixture is introduced by metering has a temperature below the provision temperature, in order to trigger the solidification operation from the time of introduction. Preferably, the temperature of the introduction zone is lower than or the same as the gelling temperature of the gel-like carrier material used. An advantageous temperature range of the introduction zone is between 20° C. and50° C., preferably between 25° C. and 48° C. As a result, a quenching of the mixture, in particular of the carrier material, which is a disadvantage for the solidification principle prevailing in the case of gel-like materials, is avoided.

According to a further advantageous development of the present invention, the fluid bath is provided in a temperature-controlled manner such that, in its removal zone in which the core bead or the active substance bead is received by a bead receiving tool for removal, it has a temperature above the freezing point of water, so that any water present in the carrier material does not freeze and therefore does not impede the solidification of the gel-like carrier material.

Under normal atmospheric pressures, a removal zone temperature of from 0.1° C. to 10° C., in particular from 1° C. to 5° C., chiefly of about 4° C., is therefore preferred. The temperature gradient discussed above is in this case the difference in temperature between the introduction zone and the removal zone, based on the distance of these two zones from one another.

It may furthermore be provided that the core bead settles particularly gently on the fluid bath base, in order to avoid as far as possible damage to the core bead.

For this purpose, the process may furthermore comprise the step of providing the fluid bath with a fluid bath base which seals off the fluid bath in a direction of introduction along which the predetermined amount of flowable mixture is introduced into the fluid bath. In this context, the fluid bath base should advantageously have a concave surface, the base radius of curvature of which exceeds the core bead radius of curvature of the core bead which forms in the fluid bath from the flowable, solidifiable mixture by not more than 30. It is then ensured, in fact, that the core bead can nestle sufficiently on the fluid bath base for a sufficiently low surface pressure to be achieved on the surface region of the core bead lying on this for damage thereof to be avoided.

The surface pressure effected on impact of the core bead on the fluid bath base can be reduced still further in that the base radius of curvature exceeds the core bead radius of curvature by not more than 20, particularly preferably by not more than 10.

In this context, the radius required for the fluid bath base can be easily determined. The amount of flowable, solidifiable material used for production of an active substance bead is as a rule known highly accurately, since this is indeed to be metered into the fluid bath. A simple consideration of the predetermined amount of flowable mixture and its density is thus sufficient for the radius of curvature of the core bead thereby formed to be predetermined sufficiently accurately.

The above statements on the solidification of the core bead in the fluid bath with provision of a temperature gradient apply equally to the advantageous solidification of the bead blank defined above if the coating material thereof can be thermally solidified.

A bead fluid bath can then advantageously be provided with a temperature gradient in a direction of introduction along which the bead blank is introduced into the bead fluid bath.

In this context, in turn, the temperature gradient is preferably chosen such that the temperature of the fluid of the bead fluid bath changes in the direction of introduction in a sense which promotes the solidification of the bead blank. The above statements on the temperature gradient of the fluid bath also apply to the fluid bath for solidification of the bead blank, with the proviso that the provision temperature of the coating material replaces the provision temperature of the flowable mixture.

To explain this development of the process according to the invention, reference is otherwise made to the above statements on the advantageous solidification of the core bead.

The above statements on the fluid bath base preferably constructed with a concave surface also apply equally to the base of the bead fluid bath used for solidification of the coating of the bead blank. Here also, with respect to the advantages of this embodiment, reference is in turn made to that which has been stated above in connection with the fluid bath base for receiving the core bead.

The present invention is explained further in the following with the aid of the accompanying figures. These show:

FIG. 1 a first embodiment of an active substance bead,

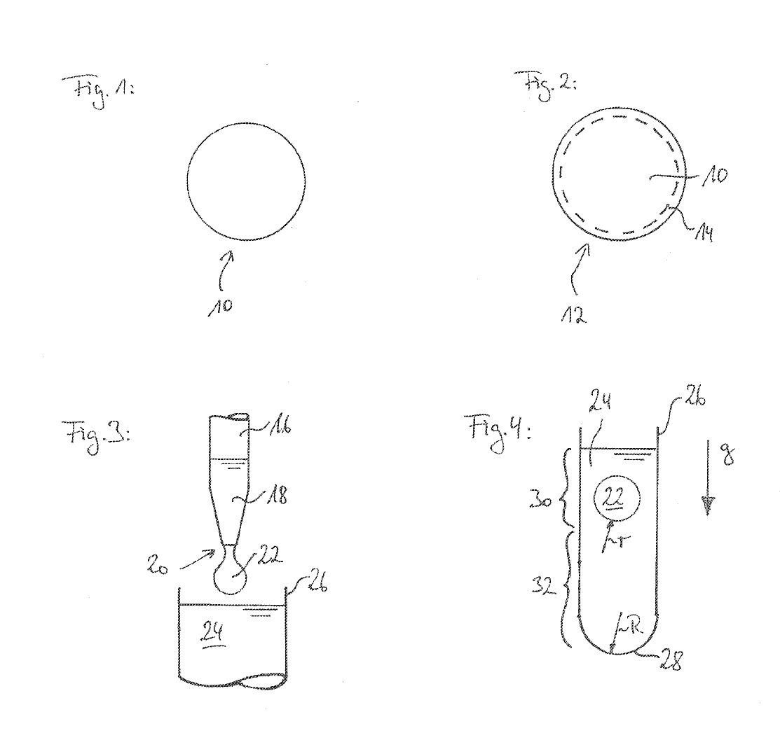

FIG. 2 a second embodiment of an active substance bead with a coating,

FIG. 3 the process step of introducing a flowable, solidifiable mixture of carrier material and biologically active material into a fluid bath,

FIG. 4 the operation of sinking of the predetermined amount of the flowable and solidifiable mixture in the fluid bath,

FIG. 5 a first alternative, utilising gravity, for automated removal of the bead solidified in the fluid bath,

FIG. 6 a bead reduced-pressure receiving tool for handling the solidified bead according to a second alternative, utilising reduced pressure,

FIG. 7 the process step of providing a coating on a sufficiently solidified core bead and

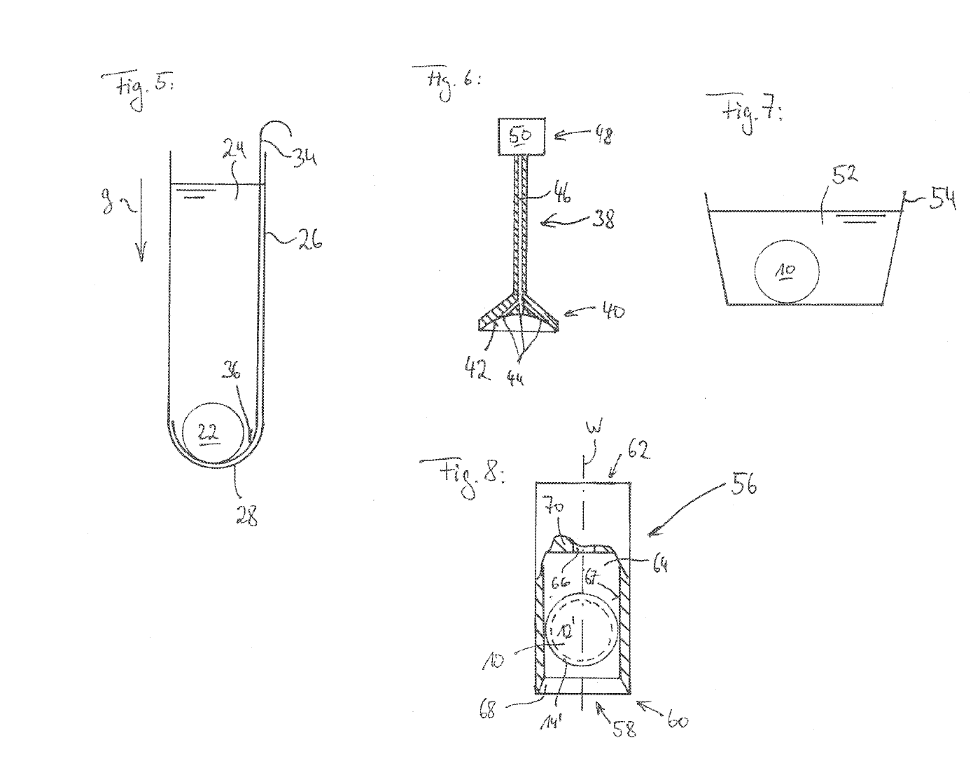

FIG. 8 a removal tool for handling a bead blank, comprising a core bead and an incompletely solidified coating around this.

In FIG. 1 a first embodiment of an active substance bead is designated generally with reference numeral 10. The active substance bead 10 comprises as a carrier material preferably a biopolymer, for example agarose, which is particularly well tolerated when implanted in the human and animal body. A biologically active substance is admixed to the carrier material in the flowable state, for example an active substance or a material which generates an active substance. For example, the biologically active material can be insulin if the active substance bead 10 is used as a depot medication.

The flowable, shapeless mass of carrier material into which the biologically active material is mixed can be brought into the spherical form shown in FIG. 1 and then solidified.

A further possible embodiment of an active substance bead is given reference numeral 12 in FIG. 2.

This active substance bead 12 can comprise a bead 10 as a core bead, which in the state of the finished active substance bead 12 is surrounded with a coating 14. For reasons of the best possible bonding of the core bead 10 and coating 14, the coating is at least partly, preferably completely formed from the carrier material of the core bead into which the biologically active material is mixed.

Active substance beads 12 with a coating 14 can be used, for example, as a cancer drug. For this purpose, a plurality of cancer cells can be embedded in the core bead 10, and are impeded in growth by the coating 14. When the cancer cells embedded in the core bead 10 have filled the space provided by the core bead and no further cell growth is possible, these cancer cells then release a chemical messenger substance which slows down or even stops the cell growth of the cancer cells. The coating 14 is permeable to this chemical messenger substance, so that it can reach the tissue surrounding the active substance bead 12. This tissue can be the tissue of a cancer patient, into which the active substance bead is implanted, so that the messenger substance released by the active substance bead can slow down or even stop the cell growth of the cancer cells in the body of the patient.

In FIGS. 1 and 2, the active substance beads 10 and 12 preferably have a spherical shape. The core bead 10 and coating 14 are not shown to scale.

FIG. 3 shows the start of a production phase for producing the active substance bead 10 or the core bead 10. A flowable but solidifiable mixture 18 of the carrier material and the biologically active material mixed into this is taken up in a metering device, for example a pipetting tip 16 known per se, which can be coupled to a pipetting device, not shown. A predetermined amount of the flowable mixture 18 is ejected as a drop 22 via the pipette opening 20 and falls into a fluid bath 24 which is provided in a container, for example a sample vessel 26.

The complete sample vessel 26 is shown schematically in FIG. 4. The drop 22 sinks in the fluid bath 24 along the gravitational direction g to the base 28 of the sample vessel 26.

Preferably, the fluid bath 24 in the sample vessel 26 is provided with at least two temperature-controlled zones 30 and 32, the first temperature-controlled zone 30 of which has a higher temperature than the second temperature-controlled zone 32 lying underneath in the gravitational direction.

The provision of different temperature-controlled zones can be effected by providing different heating and/or cooling means in the region of the temperature-controlled zones 30 and 32.

Since most fluids, in particular the oils preferred for the fluid baths 24, have a positive thermal expansion coefficient, that is to say they take up more volume with increasing temperature, which is equivalent to a decreasing density at increasing temperature, in the arrangement shown in FIG. 4 a stable stratification is achieved with a hotter first temperature-controlled zone 30 and a colder second temperature-controlled zone 32.

Furthermore, an oil, the viscosity of which increases with decreasing temperature, is preferably chosen as the fluid of the fluid bath 24, so that in particular in the second temperature-controlled zone 32 the sinking speed of the drop 22 decreases due to the increasing viscosity of the fluid.

The carrier material of the flowable, solidifiable mixture 18 is preferably chosen such that it solidifies on release of heat, until it has a certain dimensional stability.

The base 28 of the sample vessel 26 is constructed with a radius of curvature R which exceeds the radius of curvature r of the outer surface of the solidifying drop 22 by preferably not more than 30.

Damage to a possibly not yet completely solidified drop 22 in the locating engagement under the load of its own weight on the base 28 of the sample vessel 26 can thereby be avoided. Due to the similar radii of curvature R and r, the contact surface along which the solidifying drop 22 lies on the base 28 of the sample vessel 26 is so large that the surface pressure occurring due to the drop's own weight when it comes to lie on the base is low.

FIG. 5 shows a first alternative embodiment with which a drop 22 which has solidified to form a bead can be removed from the fluid bath 24 of FIGS. 3 and 4.

For this purpose, a bead gravity receiving tool 34 having an advantageously concave bead gravity contact surface 36 constructed thereon can be provided in the sample vessel 26 before the introduction of the drop 22 into the fluid bath 24.

The drop 22 of flowable, solidifiable mixture 18 introduced into the fluid bath 24 sinks in the gravitational direction g advantageously through the different temperature-controlled zones 30 and 32 and, under the action of gravity, comes into abutment with the bead gravity contact surface 36 of the bead gravity receiving tool 34. With the bead gravity receiving tool 34, the solidified drop 22 can be removed from the fluid bath 24 as a core bead 10 or active substance bead 10.

To facilitate removal, openings can be provided in the bead gravity contact surface 36 which make it possible for fluid to drain from the preferably concave region of the bead gravity contact surface 36.

In FIG. 6, equally as roughly schematically as in FIG. 5, an alternative bead reduced-pressure receiving tool 38 is shown, with which equally a core bead 10 or active substance bead 10 can be taken hold of and transported.

For this purpose, the bead reduced-pressure receiving tool 38 has on its functional longitudinal end 40 an equally preferably concave bead reduced-pressure contact surface 42, to which a reduced pressure can be applied via openings 44 leading to a working fluid channel 46.

For this purpose, the bead reduced-pressure receiving tool 38 has on its coupling longitudinal end 48 opposite the functional longitudinal end 40 preferably a coupling construction 50 with which the bead reduced-pressure receiving tool 38 can be coupled with a pipetting device, not shown, in order to generate, via the pipetting channel thereof, a reduced pressure in the channel 46 and therefore at the openings 44 in the bead reduced-pressure contact surface 42.

The bead 10 can be removed with the bead reduced-pressure receiving tool 38 from the fluid bath 24 or from the sample vessel 26 from which the fluid has been removed beforehand.

It should be added that the bead gravity receiving tool 34 is preferably at rest during creation of the abutting engagement of the solidifying drop 22 with the bead gravity contact surface 36, relative to the sample vessel 26 of the fluid bath 24, in order to avoid damage to the bead formed due to movements of the bead gravity receiving tool 34.

FIG. 7 shows how the core bead 10 produced in accordance with the process steps described above is immersed in a bath 52 of a coating material, which is provided in a container 54.

Preferably, the coating material is identical to or at least compatible with the carrier material of the flowable and solidifiable mixture 18. The coating material can therefore also preferably be thermally solidified, like the carrier material of the flowable and solidifiable mixture 18.

After it has been cleaned of the fluid of the fluid bath 24 so that fluid of the fluid bath 24 no longer adheres to its outer surface, the core bead 10 enters into the bath 52 with the coating material.

Since the core bead 10 conventionally has a lower temperature than the coating material bath 52 on immersion into the coating material bath 52, a film of flowable but solidifiable coating material adheres to the surface of the core bead 10 on immersion of the core bead 10 into the coating material bath 52.

FIG. 8 shows schematically a tool for removal of a bead blank 12′, comprising an essentially solidified core bead 10 and an incompletely solidified coating 14′, from the coating material bath 52.

This removal tool 56 shown in part section is essentially tubular, having a receiving opening 58 at its functional end 60 in order to generate, with an opposite coupling longitudinal end 62 with which the removal tool 56 can be coupled with a reduced-pressure source, preferably in turn with a previously already mentioned pipetting device, not shown, a reduced pressure around a receiving space 64 via an opening 66.

By means of this reduced pressure from the coupling longitudinal end 62, a bead blank 12′ can be sucked in through the receiving opening 58 into the receiving space 64. The diameter of the receiving space 64 in this context is preferably matched to the size to be expected for the later active substance bead 12, so that the bead blank 12′ sucked in touches a curve wall 67 along a closed track encircling the tool axis W.

A circumferential intake slope 68 in the region of the receiving opening 58 facilitates receiving of bead blanks 12′ in the receiving space 64. A radial projection 70 on the longitudinal end of the receiving space 64 which lies opposite the receiving opening 58 serves as a mechanical stop and axial limit to the movement of the bead blank 12′.

With the aid of the removal tool 8 shown in FIG. 8, the bead blank 12′ can in turn be introduced into a bead fluid bath, which essentially corresponds to that of FIGS. 4 and 5, to the description of which reference is herewith expressly made. For release of the bead blank 12′ from the receiving space, an increased pressure can be introduced into this from the coupling longitudinal end 48.

The finished active substance bead 12 can in turn be removed from the bead fluid bath with the tools 34 or 38, depending on which physical principle is to be used for this.

Removal from the bead fluid bath is effected after sufficient solidification of the initially incompletely solidified coating 14′.

After removal of the finished active substance bead 12, this is in turn cleaned of the fluid of the bead fluid bath, which may be identical to the fluid of the fluid bath described above.

After a final control, the active substance bead 12 or, in its simpler embodiment, the active substance bead 10 can be put to its intended use.

With the process presented here, individual steps of the production process for the production of an active substance bead 10 or 12 can be automated, which makes possible production of active substance beads 10 or 12 on an industrial scale, affecting the quality and piece numbers per unit time of the active substance beads 10 and 12.

1. Process for the automated production of active substance beads having a gel-like carrier material, preferably a biopolymer, such as agarose, and having embedded in the carrier material a biologically active material, such as an active substance and/or a material which generates an active substance, comprising the following steps:
a) provision of a flowable, solidifiable mixture comprising the carrier material and the biologically active material,
b) solidification of a core bead by introducing a predetermined amount of the flowable mixture into a fluid bath, preferably a liquid bath, particularly preferably an oil bath,
c) removal of the core bead from the fluid bath,
wherein, for carrying out step c), a bead contact surface of a bead receiving tool is used, and for this purpose step c) comprises either the following sub-step ca1) or the following sub-step cb1):
ca1) creation of an abutting engagement between the core bead and a preferably concave bead reduced-pressure contact surface of a bead reduced-pressure receiving tool by means of reduced pressure, or
cb1) creation of an abutting engagement between the core bead and a preferably concave bead gravity contact surface of a bead gravity receiving tool in the fluid bath by means of gravity.

2. Process according to claim 1,
wherein, before creating the abutting engagement between the core bead and the bead contact surface of the bead receiving tool, step ca1) comprises, as step ca2), emptying of the fluid bath in which the core bead is initially found.

3. Process according to claim 1,
wherein, it comprises step cb1) and, before this with respect to time over the course of the process, the following step:
cb2) provision of the bead gravity contact surface in the gravitational direction (g) at a distance from an introduction site at which the predetermined amount of the flowable mixture is introduced into the fluid bath.

4. Process according to claim 1,
wherein, it comprises the following further step:
e) cleaning of the core bead by removing fluid of the fluid bath from the core bead.

5. Process according to claim 1,
wherein, step b) comprises aspiration of an amount of the flowable mixture and dispensing of the predetermined amount of the flowable mixture into the fluid bath.

6. Process according to claim 5,
wherein, dispensing takes place such that a drop with the predetermined amount of the flowable mixture detaches itself from a pipetting device used for aspiration and dispensing, before the flowable mixture comes into contact with the fluid of the fluid bath.

7. Process according to claim 1,
wherein, it has the following further step:
f) coating of the core bead with a coating material, which preferably comprises the carrier material or a material compatible with the carrier material.

8. Process according to claim 7,
wherein, step f) comprises the following sub-steps:
f1) introduction of the core bead into a bath of flowable, solidifiable coating material,
f2) removal of a bead blank of core bead with coating material adhering thereto from the coating material bath, and
f3) solidification of the bead by introducing the bead blank into a bead fluid bath, preferably bead liquid bath, particularly preferably bead oil bath.

9. Process for the automated production of active substance beads having a gel-like carrier material, preferably a biopolymer, such as agarose, and having embedded in the carrier material a biologically active material, such as an active substance and/or a material which generates an active substance, comprising the following steps:
a) provision of a flowable, solidifiable mixture comprising the carrier material and the biologically active material,
b) solidification of a core bead by introducing a predetermined amount of the flowable mixture into a fluid bath, preferably a liquid bath, particularly preferably an oil bath,
c) removal of the core bead from the fluid bath, and
d) coating of the core bead with a coating material, which preferably comprises the carrier material or a material compatible with the carrier material,
e) wherein, step f) comprises the following sub-steps:
f1) introduction of the core bead into a bath of flowable, solidifiable coating material,
f2) removal of a bead blank of core bead with coating material adhering thereto from the coating material bath, and
f3) solidification of the bead by introducing the bead blank into a bead fluid bath, preferably bead liquid bath, particularly preferably bead oil bath.
wherein, step f2) comprises receiving the bead blank with a bead blank receiving tool, which is preferably tubular in sections, by means of reduced pressure, wherein preferably the bead blank, in a state received in the bead blank receiving tool, wets a wall section of the bead blank receiving tool, particularly preferably wets it along a closed circumferential wetting region.

10. Process according to claim 8, wherein, it furthermore comprises the following step:
g) removal of the bead from the bead fluid bath,
wherein preferably for carrying out step g) a bead contact surface of a bead receiving tool is used, and for this purpose step g) comprises either the following sub-step ga1) or the following sub-step gb1):
ga1) creation of an abutting engagement between the bead and a preferably concave bead reduced-pressure contact surface of a bead reduced-pressure receiving tool by means of reduced pressure, or
gb1) creation of an abutting engagement between the bead and a preferably concave bead gravity contact surface of a bead gravity receiving tool in the fluid bath by means of gravity.

11. Process according to claim 8,
wherein, it furthermore comprises the following step:
h) cleaning of the bead by removing fluid of the bead fluid bath from the bead.

12. Process according to claim 1,
wherein, the carrier material can be thermally solidified and step b) comprises the following step:
b1) provision of the fluid bath with a temperature gradient in a direction of introduction (g) along which the predetermined amount of flowable mixture is introduced into the fluid bath, wherein the temperature gradient is preferably chosen such that the temperature of the fluid changes in the direction of introduction (g) in a sense which promotes the solidification of the mixture.

13. Process according to claim 1,
wherein, the carrier material can be thermally solidified and step b) comprises the following step:
b2) provision of the fluid bath with a fluid bath base which seals off the fluid bath in a direction of introduction (g) along which the predetermined amount of flowable mixture is introduced into the fluid bath, wherein the fluid bath base has a concave surface, the base radius of curvature of which exceeds the core bead radius of curvature of the core bead formed in the fluid bath from the flowable, solidifiable mixture by not more than 30, preferably by not more than 20, particularly preferably by not more than 10.

14. Process according to claim 8,
wherein, the coating material can be thermally solidified and step f3) comprises the following sub-step:
f3.1) provision of the bead fluid bath with a temperature gradient in a direction of introduction (g) along which the bead blank is introduced into the bead fluid bath, wherein the temperature gradient is preferably chosen such that the temperature of the fluid changes in the direction of introduction (g) in a sense which promotes the solidification of the bead blank.

15. Process according to claim 8,
characterized in that the coating material can be thermally solidified and step f3) comprises the following sub-step:
f3.2) provision of the bead fluid bath with a bead fluid bath base which seals off the bead fluid bath in a direction of introduction (g) along which the bead blank is introduced into the bead fluid bath, wherein the bead fluid bath base has a concave surface, the base surface radius of curvature of which exceeds the bead radius of curvature of the bead which forms in the bead fluid bath from the bead blank by not more than 30, preferably by not more than 20, particularly preferably by not more than 10.
